(19) United States
(12) Patent Application Publication
(10) Pub. No.: US 2011/0301855 A1
(43) Pub. Date: Dec. 8, 2011

(54) METHOD OF PROCESSING DATA USING AN ALGORITHM FOR LINEAR EXTENSION OF THRESHOLD IN QUANTITATIVE REAL-TIME PCR DATA

(75) Inventors: Christopher Sears, Watertown, MA (US); Gabe Foster, Boston, MA (US); Mukundhan Ramaswami, Cambridge, MA (US); Kenneth J. Rothschild, Newton, MA (US)

(73) Assignee: Board of Regents, The University of Texas System

(21) Appl. No.: 13/101,662

(22) Filed: May 5, 2011

Related U.S. Application Data
(60) Provisional application No. 61/331,527, filed on May 5, 2010.

(51) Int. Cl. G06F 19/00

(52) U.S. Cl. 702/19

(57) ABSTRACT

Methods that improve the accuracy of gene expression profiling are provided, and more particularly, methods for quantitative PCT (qPCR) used to determine the level of gene expression or gene copy number in a high-throughput fashion.

### BACKGROUND OF THE INVENTION

1. Field of the Invention

This invention relates generally to methods that improve the accuracy of gene expression profiling, and more particularly, to methods for quantitative PCR (qPCR) used to determine the level of gene expression or gene copy number in a high-throughput fashion.

2. Description of the Related Art

Real-time quantitative PCR (qPCR) uses fluorescent reporter dyes to combine the amplification and detection steps of the PCR reaction in a single tube format. The assay relies on measuring the increase in fluorescent signal, which is proportional to the amount of DNA produced during each PCR cycle. Furthermore, the use of probes labeled with different reporter dyes allows the detection and quantification of multiple target genes in a single (multiplex) reaction. Individual reactions are characterized by the PCR cycle at which fluorescence first rises above a defined or threshold background fluorescence, a parameter known as the threshold cycle (Ct). The more target there is in the starting material, the lower the Ct. This correlation between fluorescence and amount of amplified product permits accurate quantification of target molecules over a wide dynamic range, while retaining the sensitivity and specificity of conventional end-point PCR assays. The closed-tube (homogeneous) format eliminates the need for post-amplification manipulation and significantly reduces hands-on time and the risk of contamination.¹

Several variables need to be controlled for in gene expression analysis, such as the amount of starting material, enzymatic efficiencies, and differences between tissues or cells in overall transcriptional activity. Various strategies have been applied to normalize these variations. To date, the internal control genes are most frequently used to normalize the mRNA fraction. This internal control gene—often referred to as a housekeeping gene—should not vary in the tissues or cells under investigation, or in response to experimental treatment. With the increased sensitivity, reproducibility, and large dynamic range of real-time PCR methods, the requirements for a proper internal control gene have become increasingly stringent.²

In real-time PCR, the rise in fluorescence with increasing cycle number reflects the efficiency of the reaction. The way real-time PCR raw data are processed and analyzed affects the accuracy of the estimation of PCR efficiency. Changes in the estimation of PCR efficiency may arise from different background subtraction, threshold setting, number of data points fitted, and the fitting algorithm used. PCR efficiency can be estimated by fitting the logarithmic phase of the amplification curve above a certain threshold to an exponential equation or by modeling the entire amplification curve. These approaches are called ‘kinetic PCR’. As long as the same procedure is used to estimate PCR efficiencies in all samples, any significant difference between estimated efficiencies should reflect differences in true efficiencies.³

What is needed is an improved system to analyze quantitative real-time PCR data.

### DESCRIPTION OF THE FIGURES

FIG. 1 shows data in the form log(delta−Rn) per cycle.

FIG. 2 shows an acceptable linear range.

### DETAILED DESCRIPTION OF THE INVENTION

Utilizing a combination of established methods and innovative techniques, we provide an improved system and method to process real time PCR data. Our rigorous methodology consistently produces accurate and reproducible results, and demonstrates a new algorithm for identifying statistically significant genes in expression profiling. Other investigators have also determined that threshold calling algorithms in qPCR software do not perform optimally and have provided alternative methods which are not as effective as described in this invention (U.S. Pat. No. 7,587,279, Li; Xitong et al.).

In one embodiment, the present invention contemplates a method of processing PCR data, comprising deriving a linear fluorescence analog formula based on the optimal geometric amplification region of an individual real-time PCR reaction. In one embodiment, the method comprises (or further comprises) deriving a marginal fluorescence threshold for all PCR reactions containing a single detector based on the previously derived linear fluorescence analog formulas. In one embodiment, the method comprises (or further comprises) applying the previously determined marginal fluorescence threshold to the linear fluorescence analog formulas to determine the threshold cycle of an individual reaction. This processing is readily performed on a computer using software that has been programmed to perform these processing steps.

A preliminary method to identify potential outliers is based on initially displaying data sets as graphical box-and-whisker plots. The rationale behind the box-and-whisker plot is as follows: the midpoint of a data set is calculated and represented by the median. A box drawn around this midpoint represents the inter-quartile range, which encompasses 50% of the range based on the 1st quartile (25% confidence level) to the 3rd quartile (75% confidence level). The whiskers outside of the box represent an additional selected range, encompassing 5% to 95% of the range of results. Data points that lay substantially beyond the range of this box-and-whisker plot are identified as potential outliers. Typically, potential outliers are identified when the value associated with a data point is larger than an upper limit of 1.5 times the height of the box, or below the lower limit of 1.5 times the height of the box. A more formal definition is outlined below:

Upper limit=(75th percentile)+(outlier coefficient*(75^{th} percentile−25^{th} percentile))

Lower limit=(25th percentile)−(outlier coefficient*(75^{th} percentile−25th percentile))

The default setting for the outlier coefficient is 1.5.

If the value associated with a data point is above the upper limit, or below the lower limit, it is thus characterized as a potential outlier.

An outlier can be defined as a data point that does not follow the typical distribution of the rest of the data set and can be regarded as an irregular observation. Example causes of outlying data points include the sample being atypical, the underlying distribution of the data set being non-normal in nature, operator error, a measurement mistake or transcription error, or purely due to chance variation. Potential outliers can arise due to this latter chance variation, where the data point is correct in nature and is simply more divergent than the majority of the data set, or they can arise due to errors where the value of the data point is erroneous. An objective test is needed to calculate the probability that a single data point is different from the rest of the data set purely due to chance alone.⁴

Outlier detection by Kinetic Outlier Detection (KOD) involves estimating the sample specific PCR efficiency from the amplification curve. Several methods for estimation of PCR efficiency are known. We use Exponential Fit (EF), where the background signal is removed by subtracting the arithmetic average of the five lowest fluorescence readings from all data points in the amplification curve. This processing is readily done on a computer. The PCR efficiency is then estimated by fitting selected points above a certain threshold to:

Rn=R0×(1+E)ⁿ

where Rn is the signal corresponding to the number of template molecules at cycle n and R0 is the signal corresponding to the initial number of template molecules. E is the PCR efficiency (0<E<1, i.e. E=1 is equal to 100% efficiency).

Having a method to estimate PCR efficiency, the next step was to set a criterion to identify deviating test samples. This was done by comparing PCR efficiency of a test sample with the efficiencies of a training set composed of 8-15 samples (e.g. dilution series) that were estimated at the same setting of threshold and number of fitted points. A test sample is classified as an outlier if

P*=2×[1−φ(|ei−μtrain|/σ)]<0.05

Here, φ is the cumulative distribution function for the standard normal distribution, ei is the observed efficiency of a test sample, μtrain is the mean efficiency of the training set and σ is the S.D. of the efficiency of the training set, here according to the optimization study.³

Once the outlier exclusion process is completed, the remaining data is passed to our innovative thresholding algorithm. Again, this is readily performed on a computer. This data is a series of Rox normalized fluorescence readings (Rn), one reading per PCR cycle.

We first perform a standard background subtraction technique on the data. We subtract the average Rn reading for all pre-amplification cycles in a particular data set from each reaction's data set. This data will be hereafter referred to as delta−Rn.

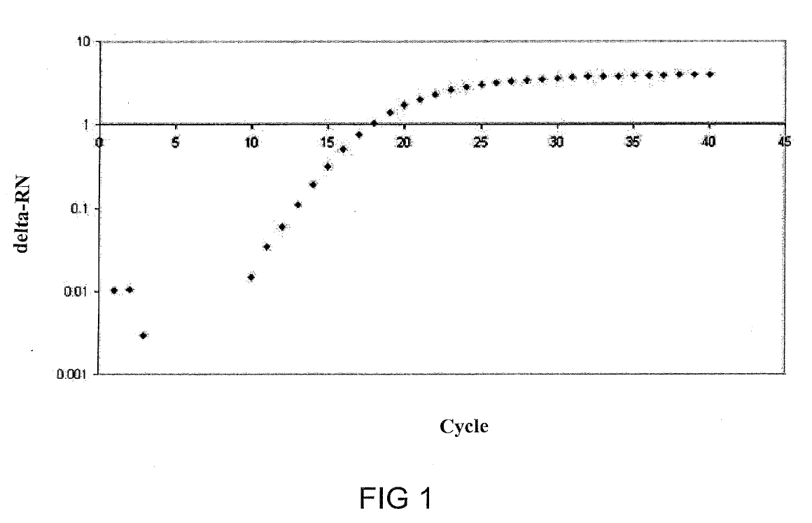

For analysis simplicity, the algorithm analyzes the data in the form log(delta−Rn) per cycle. (see FIG. 1)

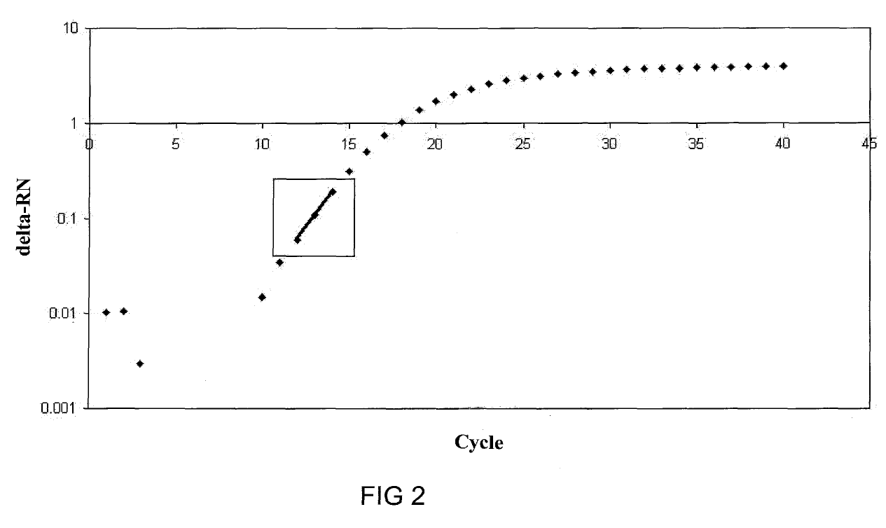

The algorithm searches the resulting curve for a 3 data point linear range. This is done using standard linear regression; an acceptable linear range must have a positive slope greater than 0.4 and less than 1.4, in order to exclude artificial linear ranges generated in the pre-amplification region and at the plateau phase. (see FIG. 2)

Any linear range with a coefficient of determination of less than 0.96 is discarded. In reactions with multiple 3 point linear ranges, the linear range with the highest slope is used in subsequent calculations.

At this point, the algorithm determines the median slope for all reactions with a specific detector. Any reaction with a linear range slope that deviates greater than 5% from the median slope for its detector has its data discarded.

Standard RT-PCR analysis typically imposes a “threshold” value. The threshold is a fluorescence reading at which an individual reaction is considered to be amplifying exponentially (which is seen as linear in our log(delta−Rn) plot). The point at which the curve crosses the threshold is called the threshold cycle (Ct). These values are used in the final analysis.

For reactions to be compared to each other accurately, the threshold must fall in the exponential amplification range of every reaction; it must also be identical in every reaction. It is often the case that these two criteria are mutually exclusive; this results in typical analysis methods generating false results.

The linear extension thresholding algorithm generates a line equation from the previously calculated linear range for each reaction in the form mx+b. The slope of this line is represented by m; the intercept is represented by b. Using the resulting lines, the same threshold can be placed anywhere and still fall in the exponential amplification region for all reactions. Our algorithm simply uses the intercept as the Ct value. The resulting Ct values are passed on to the normalization algorithm.

In order to measure expression levels accurately, normalization by multiple housekeeping genes instead of one is required. Consequently, a normalization factor based on the expression levels of the best-performing housekeeping genes must be calculated. For accurate averaging of the control genes, it is best to use the geometric mean instead of the arithmetic mean, as the former controls better for possible outlying values and abundance differences between the different genes. The number of genes used for geometric averaging is a trade-off between practical considerations and accuracy. It is apparent that an accurate normalization factor should not include the rather unstable genes that were observed in some tissues. On the other hand, it remains relatively impractical to quantify, for example, eight control genes when only a few target genes need to be studied, or when only minimal amounts of RNA are available. Furthermore, it is a waste of resources to quantify more genes than necessary if all genes are relatively stably expressed and if the normalization factor does not significantly change whether or not more genes are included.

Taking all this into consideration, the minimal use of the three most stable internal control genes for calculation of an RT-PCR normalization factor (NFn n=3) is recommended, and step-wise inclusion of more control genes until the (n+1)th gene has no significant contribution to the newly calculated normalization factor (NFₙ₊₁). To determine the possible need or utility of including more than three genes for normalization, the pair-wise variation V_{n/n+1} was calculated between the two sequential normalization factors (NFₙ and NFₙ₊₁) for all samples (with aᵢⱼ=NF_{n,1} and aᵢₖ=NF_{n+1,i}, n the number of genes used for normalization (3≦n≦9), and i the sample index). A large variation means that the added gene has a significant effect and should preferably be included for calculation of a reliable normalization factor. For all samples, normalization factors were calculated for the three most stable control genes (that is, those with the lowest M value) and for seven additional factors by step-wise inclusion of the most stable remaining control gene. Pair-wise variations were subsequently calculated for every series of NFₙ and NFₙ₊₁ normalization factors, reflecting the effect of adding an (n+1)th gene.²

### REFERENCES

1. Nolan, T., Hands, R. E. & Bustin, S. A. Quantification of mRNA using real-time RT-PCR. Nat Protoc 1, 1559-1582, doi:nprot.2006.236 [pii] 10.1038/nprot.2006.236 (2006).
² Vandesompele, J. et al. Accurate normalization of real-time quantitative RT-PCR data by geometric averaging of multiple internal control genes. Genome Biol 3, RESEARCH0034 (2002).
³ Bar, T., Stahlberg, A., Muszta, A. & Kubista, M. Kinetic Outlier Detection (KOD) in real-time PCR. Nucleic Acids Res 31, e105 (2003).
⁴ Burns, M. J., Nixon, G. J., Foy, C. A. & Harris, N. Standardisation of data from real-time quantitative PCR methods—evaluation of outliers and comparison of calibration curves. BMC Biotechnol 5, 31, doi:1472-6750-5-31 [pii] 10.1186/1472-6750-5-31 (2005).

1) A method of processing PCR data, comprising deriving a linear fluorescence analog formula based on the optimal geometric amplification region of an individual real-time PCR reaction.

2) A method of processing PCR data, comprising deriving a marginal fluorescence threshold for all PCR reactions containing a single detector based on the previously derived linear fluorescence analog formulas.

3) A method of processing PCR data, comprising applying the previously determined marginal fluorescence threshold to the linear fluorescence analog formulas to determine the threshold cycle of an individual reaction.
